(19) United States
(12) Patent Application Publication
(10) Pub. No.: US 2002/0174266 A1
(43) Pub. Date: Nov. 21, 2002

(54) Parameterized application programming interface for reconfigurable computing systems

(76) Inventors: Krishna Palem, Atlanta, GA (US); Hitesh Patel, Atlanta, GA (US); Sudhakar Yalamanchili, Marietta, GA (US)

Correspondence Address: GARY CARY WARE & FREIDENRICH LLP, 1755 EMBARCADERO ROAD, PALO ALTO, CA, 94303-3340, US

(21) Appl. No.: 09/860,942

(22) Filed: May 18, 2001

(51) Int. Cl. G06F 9/00

(52) U.S. Cl. 709/328

(57) ABSTRACT

The invention affords a system and method for programming a data processor having a microprocessor and reconfigurable logic, to attain high-speed performance while maintaining compatibility with current software programming practices by providing an API that makes the details of the interaction between the microprocessor and the reconfigurable logic units transparent to the compiler. The API virtualizes operations implemented within the reconfigurable logic unit as reconfigurable logic instructions (RL-instructions) which can be scheduled by the compiler in a manner similar to microprocessor instructions. The API provides methods for the microprocessor to configure the reconfigurable logic unit, transmit data to the reconfigurable logic unit, receive data from the reconfigurable logic unit, and otherwise interact with the reconfigurable logic unit. The set of functions that constitute the API are independent of a particular microprocessor, reconfigurable logic unit, number of reconfigurable logic units, or implementation of the API. The API implementation translates hardware dependent instructions into a set of functions that affords an implementation independent interface across all potential reconfigurable logic units. Thus, the present invention enables programming of microprocessors interacting with reconfigurable logic units using current software design processes to optimize the use of associated reconfigurable logic units.

The present invention relates to reconfigurable computing systems, and more particularly to a parameterized application programming interface for such systems.

### BACKGROUND OF THE INVENTION

The emergence of embedded applications has spawned the need for system architectures that can combine the performance of customized hardware with the generality of powerful microprocessors. Hardware vendors currently provide architectures that combine customizable hardware in the form of reconfigurable logic with traditional microprocessor cores. These hardware architectures may be integrated on a single silicon substrate, within a single multi-chip package, on a single board, or as multiple boards communicating over a backplane.

Reconfigurable logic devices can include more than one physical hardware unit and each hardware unit can be programmed to perform more than one logical function. In creating system architectures, reconfigurable logic can be connected to the microprocessor. This connection can be implemented, for example, using any medium that permits the reliable exchange of digital data between remote devices. The physical proximity of the microprocessor and the reconfigurable logic is irrelevant. They may be fabricated on the same piece of silicon or may be situated at different physical locations. Reconfigurable logic units are currently available as board-level products or as embedded systems using an industry standard input/output interface such as PCI or VME buses, serial ports, or network interfaces.

The microprocessors are typically programmed using conventional software design practices where the microprocessor program information is specified in a programming language that is translated into a sequence of simple computer instructions by a compiler. Each of these computer instructions are executed by particular hardware implementations within the microprocessor.

In contrast, the reconfigurable logic is traditionally programmed using hardware design practices where a high level functional description of a hardware design is translated into a binary encoded form that is used to configure the reconfigurable logic. The programs used to perform these translations are referred to as computer-aided design (CAD) tools.

Designing a system that uses reconfigurable logic units typically includes both a hardware design process and a software design process. The hardware design process produces a low level description of the architecture that is to be implemented with the reconfigurable logic. Depending upon the specific vendor components on which a reconfigurable logic unit is designed, third party CAD tools may be used to generate a hardware description of a low level hardware design. Using, for example, vendor provided software tools, the hardware design may be implemented within the reconfigurable logic component and a description suitable for programming the part may be generated. This description may be stored in a file or may be available as a linkable program module. The reconfigurable logic component can then be programmed at run time using vendor provided utilities and a vendor provided operating system driver.

The software design process produces an implementation of a program that will execute on the microprocessor. The program is typically written in a high level language, such as Java, C, or C++ and is usually designed based on the knowledge of the hardware design that resides in the reconfigurable logic unit. A vendor supplied API (application programming interface) may provide the procedures/functions that are used to initiate the reconfigurable logic unit, transfer data to, or read data from, the reconfigurable logic unit, and configure the unit with the design generated by the hardware design process. The partitioning of the design between the reconfigurable logic unit and the microprocessor, as well as the scheduling of data and control transfers between the reconfigurable logic unit and the microprocessor, are typically explicitly orchestrated by the programmer and the hardware designer at the time the application program is designed and implemented. Unfortunately, when a new design is generated the preceding hardware and software design steps must be repeated.

One solution to the above problem involves using a general JBits programming environment, such as is available from Xilinx Corporation, to integrate the hardware and software design processes described above. Using JBits, the reconfigurable logic units can be programmed by setting the values of single bit control signals within the reconfigurable logic units themselves. The values of all of the control signals within a reconfigurable logic unit are referred to as the configuration bitstream. Typically, configuration bitstreams are created using a hardware design process and implementing that process using CAD tools. Using a JBits API, Java applications can directly modify Xilinx device bitstreams. A hardware design for a particular reconfigurable logic unit can thus be programmed directly simply by setting the appropriate bits in the configuration bitstream.

The process of writing a JBits application to accomplish such direct programming generally involves synthesizing a design using pre-determined hardware primitive configurations built into a Xilinx chip. The advantage of using a JBits application is that executing applications can integrate reconfigurable logic computations and microprocessor computations within the same operating environment and at execution speeds far better than that conventionally achieved. The disadvantage is that complete system and hardware designs and layouts must be pregenerated by the user. This disadvantage can be ameliorated somewhat by using pre-configured libraries of common components.

Implementing a JBits programming environment generally involves two components: board description code that describes a Xilinx device and a low level hardware interface that provides access to the board through the native operating system. The low level hardware interface abstracts all but the essential details of a Xilinx reconfigurable logic component. The interface utilizes a set of functions referred to as the Xilinx HardWare InterFace (XHWIF). Using these low level functions, higher level functions can set and reset configuration bits in the bitstream. By directly manipulating configuration bits, implementations of hardware components within the reconfigurable logic unit may be generated. However, the above is limited to Xilinx devices, and cannot be readily extended to other commercially available hardware units.

Accordingly, there is a need for an application programming interface of reconfigurable logic units for a particular microprocessor and which is compatible with current software design processes for configuring a general class which facilitates the compilation of high level language programs to optimize the use of reconfigurable logic units. There is also a need to enable software developed for the microprocessor and reconfigurable logic units to be written without regard to the existence, number or capacities of the reconfigurable logic units that may be coupled with the microprocessor. It is to these ends that the present invention is directed.

### SUMMARY OF THE INVENTION

The present invention affords a system and method for programming a data processor having a microprocessor and reconfigurable logic, to attain high-speed performance while maintaining compatibility with current software programming practices using an API that makes the details of the interaction between the microprocessor and the reconfigurable logic units substantially transparent to the compiler.

The invention provides an API that virtualizes operations implemented within the reconfigurable logic units as reconfigurable logic instructions (RL-instructions) which can be scheduled by the compiler in a manner similar to microprocessor instructions. The API enables the microprocessor to configure the reconfigurable logic units, transmit data to the reconfigurable logic units, receive data from the reconfigurable logic units, and otherwise interact with the reconfigurable logic units. The set of functions that constitute the API are independent of a particular microprocessor, reconfigurable logic unit, number of reconfigurable logic units, or implementation of the API.

The API implementation translates hardware dependent instructions into a set of functions that affords an implementation independent interface across all potential reconfigurable logic units. The API is preferably parameterized to enable the implementation to be scaled with addition of new RL-instructions. Additional RL-instructions can be added without having to recompile existing programs. The API can determine if an RL-instruction is available for a specific RL-component and if not can provide access to a software implementation of the same RL-instruction. The API enables the compiler to compose RL-instructions into larger instruction block sequences to produce more efficient implementations of existing programs. Thus, the present invention enables programming of microprocessors interacting with reconfigurable logic units using current software design processes to optimize the use of associated reconfigurable logic units.

Accordingly, microprocessor hardware and reconfigurable logic components can be treated uniformly enabling a single homogenous development environment of compilers, simulators, debuggers, etc. Using the invention, an application developer may choose a desired system platform for developing an executable application by designating a particular programming language, microprocessor and reconfigurable logic combination. The parameterized API is independent of the hardware platform and permits code executing on the microprocessor to communicate with instructions implemented by the reconfigurable logic. The hardware platform in turn can be any combination of commercial off-the-shelf microprocessor and reconfigurable logic components.

In an aspect, the invention affords an application programming interface for communicating data between a microprocessor and one or more reconfigurable logic units in an embedded data processor. The application programming interface comprises a logical abstraction layer that maintains reconfigurable logic based instruction specific information relating to the reconfigurable logic units in the embedded data processor. The logical abstraction layer provides a function call interface to application programs executing on the microprocessor. The application programming interface also comprises a hardware abstraction layer that maintains hardware specific information relating to the microprocessor. The hardware abstraction layer translates reconfigurable logic instruction operations from the executing application programs to an associated set of reconfigurable logic instruction operations for moving data and control information between the reconfigurable logic units and the microprocessor. The application programming interface further comprises a shared memory interface for associating particular reconfigurable logic instructions with the microprocessor specific instructions so that the microprocessor specific instructions from the executing application programs can communicate with one or more of the reconfigurable logic units of the embedded data processor.

In other aspects, the invention enables the hardware abstraction layer to define a set of functions that implement an independent interface with the reconfigurable logic units of the embedded data processor. The hardware abstraction layer also maintains a memory map for the address space of the reconfigurable logic component executing a reconfigurable logic instruction. The memory map defines the memory addresses to be written to for passing the data contained therein to the reconfigurable logic instruction for execution by the reconfigurable logic unit, and the memory addresses at which the results obtained by executing the reconfigurable logic instruction can be read by the microprocessor. The hardware abstraction layer translates references to these memory addresses into mechanisms for communicating data to and from the reconfigurable logic units.

In other aspects of the invention, the shared memory interface comprises a set of memory locations associated with the reconfigurable logic units. Respective input and output parameters of the reconfigurable logic instructions are mapped to the set of memory locations for execution of particular reconfigurable logic instructions by a particular reconfigurable logic component in the embedded data processor. Further, each reconfigurable logic unit of the embedded data processor is provided with a distinct memory address space, and each reconfigurable logic instruction is assigned a unique set of memory addresses in the memory address space. Additionally, for a given reconfigurable logic instruction, read operations from assigned addresses in the shared address space causes data to be transferred from the reconfigurable logic instruction to the microprocessor, and write operations to assigned addresses in the shared address space causes data to be transferred from the microprocessor to the reconfigurable logic instruction for execution of the instruction by a reconfigurable logic unit.

In still other aspects, data and control information include any of input data to the reconfigurable logic unit, output data from the reconfigurable logic unit, control information between the microprocessor and reconfigurable logic unit indicating the status of the communication between them, and control information between the microprocessor and reconfigurable logic unit indicating the status of the instruction being executed by the reconfigurable logic unit.

Multiple reconfigurable logic instructions may execute concurrently on distinct reconfigurable logic units in the embedded data processor or in the same reconfigurable logic unit. The interface is preferably parameterized so as to include a unique instruction identifier, such as an instruction opcode, which operates as an argument to the associated procedure or function, for each instruction to be performed by a reconfigurable logic unit executing the instruction. The interface includes one or more internal data structures that contain information about each reconfigurable logic instruction, such as information about a reconfigurable logic instruction that is executed by software instead of a reconfigurable logic unit, a list of reconfigurable logic instruction arguments, a list of reconfigurable logic instruction argument types, and a location of a particular reconfigurable logic instruction in the shared memory interface. Advantageously, additional reconfigurable logic instructions can be added to the instruction set without modifying the reconfigurable logic unit implementation for executing existing reconfigurable logic instructions.

In another aspect, the invention affords a method for relocating reconfigurable logic instructions with the reconfigurable logic unit. This capability can be used advantageously to dynamically reconfigure the reconfigurable logic unit for the purposes of minimizing power dissipation or achieving lower execution time performance. The invention affords this capability by maintaining location information in the API in such a manner as to use this information when the microprocessor program is executing and not fixing this information at the time the microprocessor program is compiled.

In another aspect, the invention affords a method for programming a data processor having a microprocessor and one or more reconfigurable logic units, comprising the steps of maintaining reconfigurable logic based instruction specific information relating to the reconfigurable logic units that provide a function call interface to application programs executing on the microprocessor; maintaining hardware specific information relating to the microprocessor and translating microprocessor instruction operations from the executing application programs to an associated set of reconfigurable logic instruction operations for moving data and control information between the reconfigurable logic units and the microprocessor; and providing a shared memory interface for associating particular reconfigurable logic instructions with the microprocessor specific instructions so that the microprocessor specific instructions from the executing application programs can be executed by one or more of the reconfigurable logic units of the embedded data processor.

In the invention, a set of functions may be defined that provide an implementation independent interface with the reconfigurable logic units. Further, a memory map for the address space of the reconfigurable logic component executing a reconfigurable logic instruction may be maintained. The memory map may define the memory addresses to be written to for passing the data contained therein to the reconfigurable logic instruction for execution by the reconfigurable logic unit, and the memory addresses at which the results obtained by executing the reconfigurable logic instruction can be read by the microprocessor. In addition, references to these memory addresses may be translated into mechanisms for communicating data to and from the reconfigurable logic units. A set of memory locations may be associated with the reconfigurable logic units, and respective input and output parameters of the reconfigurable logic instructions may be mapped to the set of memory locations for execution of particular reconfigurable logic instructions by a particular reconfigurable logic component in the embedded data processor.

### BRIEF DESCRIPTION OF THE DRAWINGS

FIG. 1 is an operational view of an embedded data processor;

FIG. 2 is a diagram illustrating a relationship between API layers of the invention and the microprocessor and reconfigurable logic component of an embedded data processor;

FIG. 3 is a diagrammatic view of a set of memory addresses for an embedded data processor that function as a shared memory interface in accordance with the invention for associating particular RL instructions with those for executing on a microprocessor in an embedded data processor;

FIG. 4 is exemplary pseudo-code description of user application code for executing on the microprocessor of an embedded data processor with a function call to an RL based instruction for performing 32-bit multiplication on two operands and returning the result; and

FIG. 5 is exemplary pseudo-code description of the user application code of FIG. 4 translated by a compiler into API call sequences for performing the application code operation by reconfigurable logic in the embedded data processor in accordance with the invention.

### DETAILED DESCRIPTION OF THE PREFERRED EMBODIMENT

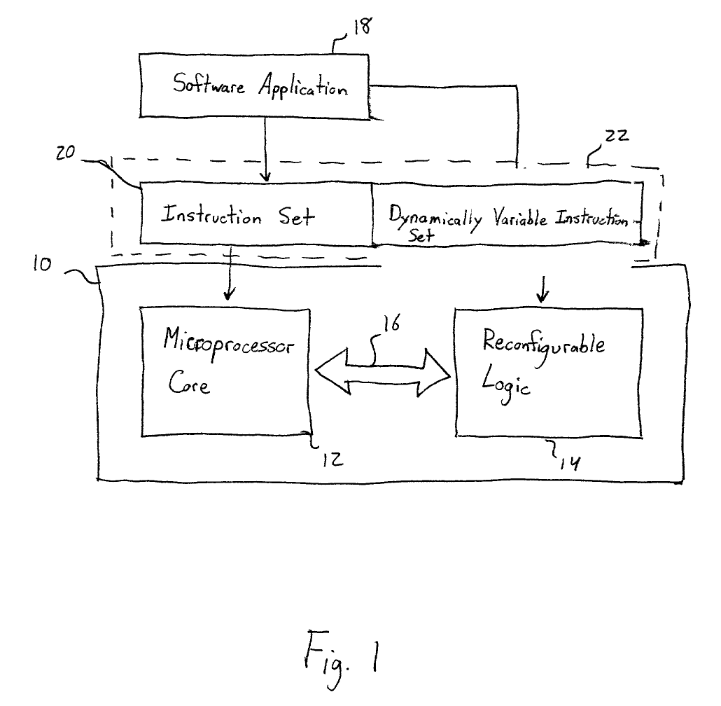

FIG. 1 is an operational view of an embedded data processor 10. The embedded data processor 10 includes a microprocessor core 12 and a reconfigurable logic component 14. The physical proximity of the microprocessor core 12 and the reconfigurable logic component 14 is irrelevant. They may be fabricated on the same piece of silicon or may be situated in different physical locations. Regardless, the microprocessor core 12 and the reconfigurable logic component 14 communicate over an interface bus 16. This interface bus 16 may be a shared medium or dedicated to communication between the microprocessor 12 and reconfigurable logic unit 14.

An application program 18 written in a high level language, such as Java, C, or C++, for example, may be translated by a compiler (not shown) into a sequence of instructions 20 that may be executed on the microprocessor 12. FIG. 1 illustrates two types of instruction sets that may include instructions for executing on the underlying hardware; a generic instruction set 20, and a dynamically variable instruction set 22 that serves to extend the generic instruction set 20. The generic instruction set 20 may include a set of instructions that are executed on the microprocessor 12, while the dynamically variable instruction set 22 may include a set of instructions that are executed on the reconfigurable logic 14, such as is described in detail in co-pending patent application Ser. No. 09/715,578, entitled “An Instruction Set Architecture to Aid Code Generation for Hardware Platforms Having Multiple Heterogeneous Functional Units,” which is incorporated herein by reference. Those skilled in the art will recognize that other types of instructions may also be provided, and the above are merely exemplary. Advantageously, the invention affords the communication of data between microprocessor-based instructions and reconfigurable logic-based instructions (RL instructions) using a unique API. The API transparentalizes the details of the communication protocol (between the microprocessor 12 and the reconfigurable logic component 14), and enables compiler optimization of resulting application code that is not feasible with conventional APIs. For example, whereas conventional APIs focus on, and virtualize, the communication between the microprocessor 12 and reconfigurable logic device 14, this aspect of the invention virtualizes the operations performed in the reconfigurable logic unit 14 as an instruction with properties similar to that of microprocessor instructions. As a result, compiler optimizations can be developed to schedule reconfigurable logic instructions in a manner similar to that practiced in the state of the art for microprocessors.

Software applications for executing on the embedded data processor 10 may themselves include one or more RL instructions to be executed by a reconfigurable logic component 14. Instruction sequences may also be generated by a compiler to create executable software application code for executing on the embedded data processor 10 that may also include one or more RL instructions to be executed by a reconfigurable logic component 14. A given reconfigurable logic component 14 may implement one or more RL instructions at any point in time. Accordingly, over a period of time corresponding to the execution of the software application, a reconfigurable logic component 14 may be dynamically configured and reconfigured to host (execute) one or more of the RL instructions.

For example, consider the case wherein there are two reconfigurable logic instructions to be executed by a reconfigurable logic unit: an integer multiplication operation, and an integer division operation. Consider also a sequence of microprocessor instructions wherein the RL multiplication instruction occurs first, followed by the RL division instruction. Now consider the case wherein the reconfigurable logic unit is large enough to be configured with both a hardware multiplier to execute the multiplication instruction in the RL, and a hardware divide unit to execute the division instruction in the RL. The reconfigurable logic unit is configured once with the multiplier and divider at the start of program execution. The API is used to communicate data and results between the microprocessor and the reconfigurable logic unit that is configured with the multiplier and divider. Now consider the case where only one of the multiplier or divider can be placed in the RL at a time. In such a case, the RL may first be configured with the multiplier. The API is used to communicate data and results between the microprocessor and the reconfigurable logic unit that is configured with the multiplier. The RL may now be configured to implement the divider using the API functions. The API is again used to communicate data and results between the microprocessor and the reconfigurable logic unit that is configured with the divider. This approach can be extended to the case where there are many RL instructions that cannot be concurrently implemented in the reconfigurable logic unit.

In another aspect of the invention, the ability to reconfigure the device over time may be used to advantageously minimize power dissipation. Accordingly, even if multiple instructions can be concurrently implemented with the reconfigurable logic unit, it is noted that all instructions consume some amount of power even when they are inactive. Accordingly, the power utilized to reconfigure the chip to use the RL instruction may be less than the power dissipated by an RL instruction resident for a long period of time. The invention abstracts placement and configuration information for an RL instruction in a manner that permits state of the art compilers to optimize power dissipation by dynamically placing instructions at different locations in the array in a demand driven manner rather than placing all instructions at the beginning.

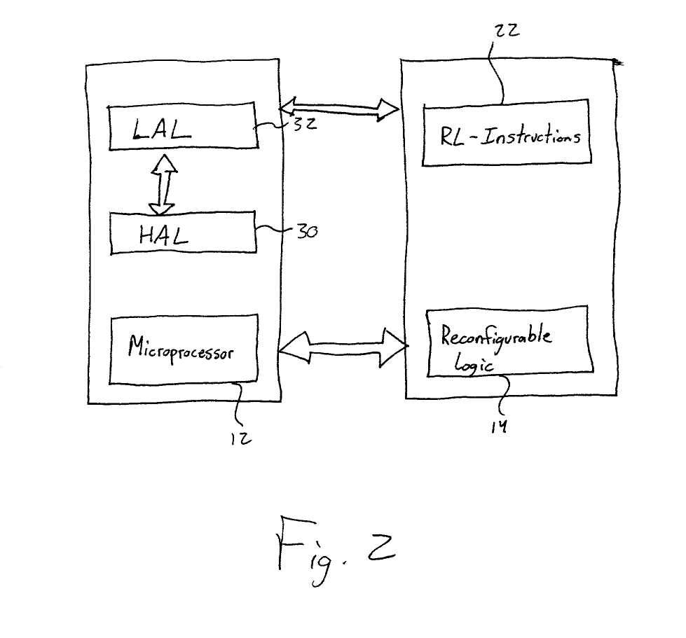

In yet another example, a RL instruction may define an operation that would otherwise require many microprocessor instructions to perform. Examples of such operations include, for example, a multiply accumulate operation over a set of data items, and the shift mask extract operation. Using the invention, a precisely defined interface provides the application code executing on the microprocessor 12 with a set of functions to enable the correct initiation, execution, and termination of associated RL instructions. For example, the interface may include functions for initializing the particular RL instruction, transferring of data to and from a particular reconfigurable logic component 14 for executing that instruction, and error checking. Advantageously, the interface remains consistent across distinct microprocessor 12 and reconfigurable logic component 14 combinations by executing in the user address space of the embedded processor 10. The interface will now be described in more detail with reference to FIG. 2 which illustrates a relationship between the API layers of the invention and the microprocessor 12 and reconfigurable logic component 14 of an embedded data processor 10.

Implementing the interface of the invention involves several aspects. For example, hardware specific details of the reconfigurable logic unit 14 may be captured and defined in a Hardware Abstraction Layer (HAL) 30. The HAL 30 is provided as a set of functions to enable the correct initiation, execution, and termination of associated RL instructions. Additionally, RL instruction specific details may be captured and defined in a Logical Abstraction Layer (LAL) 32. The LAL 32 provides data structures to enable the scalable addition of RL instructions whose implementation is realized as a sequence of HAL 30 invocations.

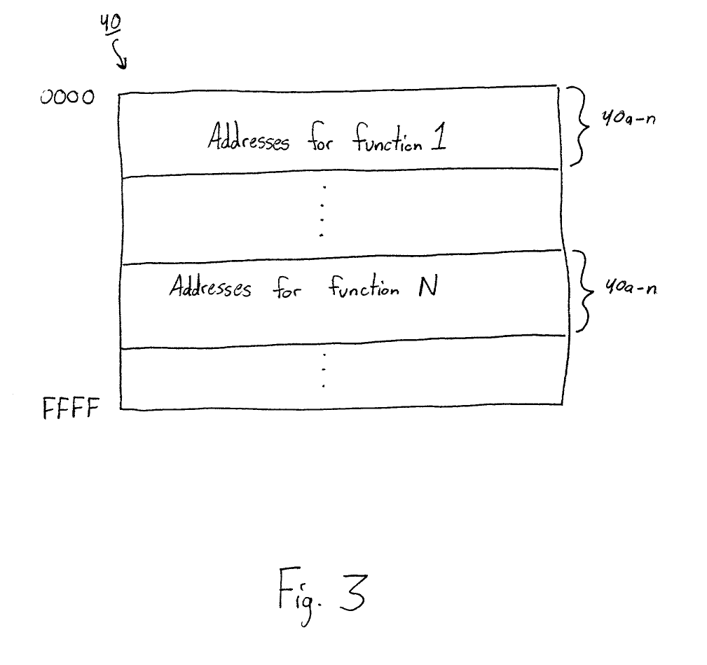

The Hardware Abstraction Layer 30 generally defines a set of functions that provide an implementation independent interface to a reconfigurable logic component 14. To provide this implementation independent interface, a set of memory addresses may be utilized, as will be described with reference to FIG. 3. FIG. 3 is a diagrammatic view of a set of memory addresses 40a-n for an embedded data processor 10 that may be established in the user address space of the data processor 10. These memory addresses 40a-n function as a shared memory interface 40 to associate particular RL instructions with those for executing on a microprocessor 12. Using the invention, a reconfigurable logic component 14 may be abstracted as a set of memory locations 40a-n referred to as the address space of a reconfigurable logic component 14. Accordingly, the input and output parameters of a RL instruction can be mapped to a set of memory locations 40a-n within this shared address space 40. For example, read and write operations on this shared address space 40 implement data transfers to and from a particular RL instruction for execution by a reconfigurable logic component 14 in the embedded data processor 10. This description includes the case where the RL instruction is itself comprised of multiple operations that could independently be otherwise viewed as RL instructions themselves. For example, the RL instruction might be viewed as a vector summation operation or a two operand multiplication operation. In other words, the invention is applicable to instructions at multiple granularities. The method to create such multi-granular RL instructions is beyond the scope of this invention.

The implementation of this shared memory interface 40 may be captured as a set of functions and procedures that comprise the Hardware Abstraction Layer 30 (FIG. 2). Thus, the HAL layer 30 encapsulates device specific information, and translates read and write operations on the shared address space 40 to an associated set of operations required to physically move data and control information between a reconfigurable logic component 14 and the host microprocessor 12 in an embedded data processor 10. Accordingly, the HAL layer 30 is an implementation dependent layer.

The HAL layer 30 may provide a range of functionality, some of which is described below. Among the provided functionality, each reconfigurable logic component 14 of the embedded data processor 10 may be provided with a distinct address space 40, such as is illustrated in FIG. 3. Each instruction that may be implemented in the reconfigurable logic 14 may be provided with a unique set of addresses 40a-n in that address space 40. For a given RL instruction, read operations from assigned addresses 40a-n in the shared address space 40 may cause data to be transferred from the RL instruction to the microprocessor 12. Similarly, for a given RL instruction, write operations to assigned addresses 40a-n in the shared address space 40 may cause data to be transferred from the microprocessor 12 to the RL instruction for execution by a reconfigurable logic component 14. Those skilled in the art will recognize that alternative implementations of this hardware independent interface are feasible and the above is merely exemplary.

The LAL layer 32 (FIG. 2) provides a function call interface to application programs executing on the microprocessor 12. The interface preferably hides the hardware implementation details of the microprocessor 12 from the compiler or the user. From an application's perspective, the interface operations are independent of the specific combination of microprocessor 12 and reconfigurable logic components 14 that comprise the target hardware.

In accordance with the invention, the interface may implement a logical communication channel between the microprocessor 12 and each RL instruction. However, all of the logical channels corresponding to multiple RL instructions within a reconfigurable logic component 14 may share the same physical communication channel to the microprocessor 12. The logical channel allows the exchange of information, for example, data or control information, between the microprocessor 12 and a given instruction implemented in a reconfigurable logic component 14. Examples of data that may be exchanged via the logic channel include data that may be required by the instruction as inputs to the reconfigurable logic component 14, control information between the microprocessor 12 and reconfigurable logic component 14 indicating the status of the communication between the hardware, or the status of the instruction being executed. On successful completion of the instruction, output data may be communicated back to the microprocessor 12 via the logical communication channel.

A complex application may have several instructions executing concurrently on distinct reconfigurable logic components 14. In such an environment, the ability to provide error signals to the application can significantly enhance product development. For example, consider an error that occurs in an RL instruction and is diagnosed in the HAL 30. This error can be propagated to the LAL 32 and then to the application through an error notification and handling interface. Accurate and informative error messaging results in a quick identification and correction of the source code producing the error. Without the propagation of error information to the application, the developer is left to hypothesize the source of the error, executing and collecting experimental data for analysis. These steps add to the product development cycle. Accordingly, the invention accommodates error checking features, such as time-outs, preemption, and status updates, among others.

Advantageously, the interface is parameterized where a unique instruction identifier, such as an instruction opcode, for example, forms an argument to the associated procedures/functions. Further, API internal data structures contain information about each instruction. Examples of the information that may be contained in internal data structures include information about an instruction not having a reconfigurable logic implementation, but instead being implemented in software, lists of arguments and their type, and the location of a RL instruction in the address space of the local device.

Accordingly, the API internal data structures are designed such that new instructions can be added to the instruction set without modifying the implementation of existing instructions. Thus, the addition of new RL instructions does not change the operational nature of the API. As a result, new instructions can be added, for example, by rebuilding the run-time that forms the implementation of the API. Further, existing applications need not be recompiled if the target hardware system has not changed. Thus, the invention provides a parameterized API software interface that is advantageously more expandable, scalable, and maintainable than conventional API solutions.

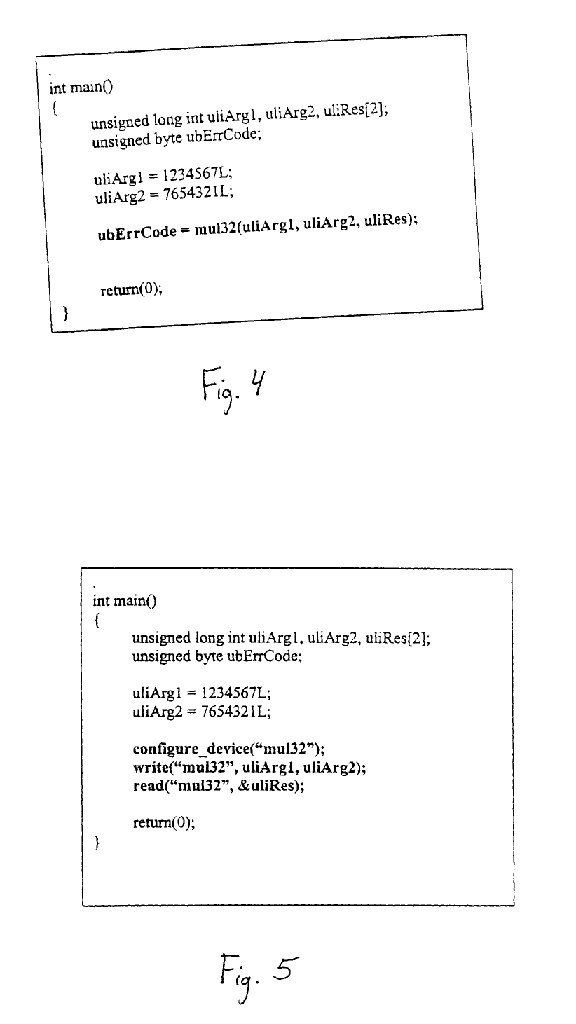

Operation of the API of the invention will now be described. FIG. 4 is exemplary pseudo-code description of user application code with a function call to an RL based instruction for performing 32-bit multiplication on two operands and returning the result. Such instructions can be readily translated by the compiler into a suitable sequence of API calls using techniques that are well known in the art. FIG. 5 is exemplary code description of the user application code of FIG. 4 translated into API call sequences. The translation is independent of the specific implementation platform. Target hardware dependent functionality, such as data transfer mechanisms by which the reconfigurable logic component 14 can be accessed, is hidden from the compiler or the user and exists in the implementation of the HAL 30 which is referred to by each of the calls illustrated in FIG. 5.

Referring to the relevant portions 50, 60 of FIGS. 4 and 5, exemplary application code for performing the multiplication operation is illustrated as the following operation:

mul32(uliArg1, uliArg2, uliRes);

When translated by the compiler, the above operation may result in the following code for invoking the API which is illustrated as the following operation calls:

configure_device(“mul32”);

write(“mul32”, uliArg1, uliArg2);

read(“mul32”, &uliRes);

When an API function/procedure is invoked, the arguments passed to the respective function or procedure may include a parameter that denotes the specific RL instruction being referenced. For example, in the above example, the RL instruction being referenced is “mul32”. This parameter may be used to query a data structure to determine if an RL implementation of the RL instruction being referenced is available. If such an implementation is not available, a software implementation may be invoked instead.

If a hardware implementation of the referenced instruction is available, the HAL layer 30 is invoked to perform the necessary read or write operation. The HAL layer 30 may maintain a memory map for the address space 40 of the reconfigurable logic component 14 that implements the instruction. The address map defines the addresses to be written to pass data to the instruction and the addresses at which the results produced by the instruction can be read. Internally, the HAL layer 30 translates references to these addresses into mechanisms necessary to communicate data to and from the reconfigurable logic component 14.

Accordingly, the invention allows an application developer to choose a desired platform in the form of a programming language, a microprocessor, and reconfigurable logic. A parameterized API independent of the hardware platform permits code executing on the microprocessor to communicate with functions implemented within the reconfigurable logic. The hardware platform can be any combination of commercial off-the-shelf microprocessor and reconfigurable logic components.

What is claimed is:

1. An application programming interface for communicating data between a microprocessor and one or more reconfigurable logic units in an embedded data processor, comprising:
a logical abstraction layer maintaining reconfigurable logic based instruction specific information relating to the reconfigurable logic units, the logical abstraction layer providing a function call interface to application programs executing on the microprocessor;
a hardware abstraction layer maintaining hardware specific information relating to the microprocessor, the hardware abstraction layer translating microprocessor instruction operations from the executing application programs to an associated set of reconfigurable logic instruction operations for moving data and control information between the reconfigurable logic units and the microprocessor; and
a shared memory interface for associating particular reconfigurable logic instructions with the microprocessor specific instructions so that the microprocessor specific instructions from the executing application programs can be executed by one or more of the reconfigurable logic units of the embedded data processor.

2. The application programming interface of claim 1, wherein the hardware abstraction layer defines a set of functions that provide an implementation independent interface with the reconfigurable logic units.

3. The application programming interface of claim 1, wherein the hardware abstraction layer maintains a memory map for the address space of the reconfigurable logic component executing a reconfigurable logic instruction, the memory map defining the memory addresses to be written to for passing the data contained therein to the reconfigurable logic instruction for execution by the reconfigurable logic unit, and the memory addresses at which the results obtained by executing the reconfigurable logic instruction can be read by the microprocessor.

4. The application programming interface of claim 1, wherein the hardware abstraction layer translates references to these memory addresses into sequences of physical addresses for communicating data to and from the reconfigurable logic units.

5. The application programming interface of claim 1, wherein the shared memory interface comprises a set of memory locations associated the reconfigurable logic units, and wherein respective input and output parameters of the reconfigurable logic instructions are mapped to the set of memory locations for execution of particular reconfigurable logic instructions by a particular reconfigurable logic component in the embedded data processor.

6. The application programming interface of claim 1, wherein each reconfigurable logic unit of the embedded data processor is provided with a distinct memory address space, and wherein each reconfigurable logic instruction is assigned a unique set of memory addresses in the memory address space.

7. The application programming interface of claim 6, wherein for a given reconfigurable logic instruction, read operations from assigned addresses in the shared address space causes data to be transferred from the reconfigurable logic instruction to the microprocessor, and wherein write operations to assigned addresses in the shared address space causes data to be transferred from the microprocessor to the reconfigurable logic instruction for execution of the instruction by a reconfigurable logic unit.

8. The application programming interface of claim 1, wherein the data and control information includes any of input data to the reconfigurable logic unit, output data from the reconfigurable logic unit, control information between the microprocessor and reconfigurable logic unit indicating the status of the communication between them, and control information between the microprocessor and reconfigurable logic unit indicating the status of the instruction being executed by the reconfigurable logic unit.

9. The application programming interface of claim 1, wherein multiple reconfigurable logic instructions are executing concurrently on distinct reconfigurable logic units.

10. The application programming interface of claim 1, wherein the interface is parameterized so as to include a unique instruction identifier for each instruction which operates as an argument to the associated procedure or function to be performed by a reconfigurable logic unit executing the instruction.

11. The application programming interface of claim 10, wherein the instruction identifier is an instruction opcode.

12. The application programming interface of claim 1, wherein the interface includes one or more internal data structures that contain information about each reconfigurable logic instruction.

13. The application programming interface of claim 12, wherein the information includes any of information about a reconfigurable logic instruction that is executed by software instead of a reconfigurable logic unit, a list of reconfigurable logic instruction arguments, a list of reconfigurable logic instruction argument types, and a location of a particular reconfigurable logic instruction in the shared memory interface.

14. The application programming interface of claim 1, wherein additional reconfigurable logic instructions can be added to the instruction set without modifying the reconfigurable logic unit implementation for executing existing reconfigurable logic instructions.

15. A method for programming a data processor having a microprocessor and one or more reconfigurable logic units, comprising the steps of:
maintaining reconfigurable logic based instruction specific information relating to the reconfigurable logic units that provide a function call interface to application programs executing on the microprocessor;
maintaining hardware specific information relating to the microprocessor and translating microprocessor instruction operations from the executing application programs to an associated set of reconfigurable logic instruction operations for moving data and control information between the reconfigurable logic units and the microprocessor; and
providing a shared memory interface for associating particular reconfigurable logic instructions with the microprocessor specific instructions so that the microprocessor specific instructions from the executing application programs can be executed by one or more of the reconfigurable logic units of the embedded data processor.

16. The method of claim 15, further comprising the step of defining a set of functions that provide an implementation independent interface with the reconfigurable logic units.

17. The method of claim 15, further comprising the step of maintaining a memory map for the address space of the reconfigurable logic component executing a reconfigurable logic instruction, the memory map defining the memory addresses to be written to for passing the data contained therein to the reconfigurable logic instruction for execution by the reconfigurable logic unit, and the memory addresses at which the results obtained by executing the reconfigurable logic instruction can be read by the microprocessor.

18. The method of claim 17, further comprising the step of translating references to these memory addresses into sequences of physical addresses for communicating data to and from the reconfigurable logic units.

19. The method of claim 15, further comprising the step of associating a set of memory locations with the reconfigurable logic units, and mapping respective input and output parameters of the reconfigurable logic instructions to the set of memory locations for execution of particular reconfigurable logic instructions by a particular reconfigurable logic component in the embedded data processor.
